(19) United States
(12) Patent Application Publication
(10) Pub. No.: US 2023/0311536 A1
(43) Pub. Date: Oct. 5, 2023

(54) RECORDING SYSTEM

(71) Applicant: SEIKO EPSON CORPORATION, Tokyo (JP)

(72) Inventor: Masahiro MURATA, Shiojiri (JP)

(21) Appl. No.: 18/191,049

(22) Filed: Mar. 28, 2023

(30) Foreign Application Priority Data
Mar. 30, 2022 (JP) 2022-055058

(51) Int. Cl. B41J 2/21; H04N 1/60; H04N 1/54

(52) U.S. Cl. CPC B41J 2/2132; H04N 1/6019; H04N 1/54

(57) ABSTRACT

A recording system includes a recording head including a plurality of nozzles configured to discharge liquid, and a control unit configured to control the recording head. The control unit is configured to control discharge of the liquid by the recording head based on a total discharge amount, of the liquid, corresponding to a color of input data, and perform control to discharge a peak total discharge amount of the liquid when a predetermined color belonging to a first range in a color space of the input data is input as the color of the input data, the peak total discharge amount is greater than the total discharge amount corresponding to a darkest portion of the color space, and the first range is a range of 1/25.5 or less excluding the darkest portion when the darkest portion is 0 and a brightest portion of the color space is 1.

The present application is based on, and claims priority from JP Application Serial Number 2022-055058, filed Mar. 30, 2022, the disclosure of which is hereby incorporated by reference herein in its entirety.

### BACKGROUND

### 1. Technical Field

The present disclosure relates to a recording system that controls a recording head capable of discharging liquid.

### 2. Related Art

In a recording device or system that performs recording by discharging liquid such as ink by a recording head, color conversion processing for converting input data expressed in a certain color space into a discharge amount of each color of ink that can be discharged by the recording head is performed.

As a related art, there is disclosed a color conversion table which is used in a color mode by a color conversion unit and which indicates a print amount of color ink of CMYK with respect to an input signal value RGB (see FIG. 24A of JP-A-2013-233713).

As in the color conversion table of the related art, when an input signal value corresponding to a peak of the print amount of the combination of CMYK is separated to some extent from an input signal=0 which is the darkest portion, the print amount corresponding to a neighboring color of the darkest portion is likely to be insufficient, and in a recording result, there is a problem in that filling of a paper surface of the neighboring color is poor and image quality is likely to deteriorate.

### SUMMARY

A recording system includes a recording head including a plurality of nozzles configured to discharge liquid onto a medium, and a control unit configured to control the recording head, wherein the control unit is configured to control discharge of the liquid by the recording head based on a total discharge amount, of the liquid, corresponding to a color of input data, and perform control to discharge a peak total discharge amount of the liquid when a predetermined color belonging to a first range in a color space of the input data is input as the color of the input data, the peak total discharge amount is greater than the total discharge amount corresponding to a darkest portion of the color space, and the first range is a range of 1/25.5 or less excluding the darkest portion when the darkest portion is 0 and a brightest portion of the color space is 1.

### BRIEF DESCRIPTION OF THE DRAWINGS

FIG. 1 is a block diagram simply illustrating a system configuration of a present exemplary embodiment.

FIG. 2 is a diagram simply illustrating a relationship between a medium and a recording head when viewed from above.

FIG. 3 is a flowchart illustrating recording control processing.

FIG. 4 is a diagram simply illustrating a part of a color conversion LUT of the present exemplary embodiment in an RGB color space.

FIGS. 5A and 5B are diagrams showing a color conversion LUT as a comparative example, respectively.

FIG. 6A is a diagram showing the color conversion LUT as a comparative example, and FIG. 6B is a diagram showing an example of the color conversion LUT of the present exemplary embodiment.

FIG. 7 is a flowchart illustrating an example of grid point position change processing.

### DESCRIPTION OF EXEMPLARY EMBODIMENTS

Embodiments of the present disclosure will be described below with reference to the accompanying drawings. Note that each of the drawings is merely illustrative for describing the embodiment. Since the drawings are illustrative, proportions and shapes may not be precise, match each other, or some may be omitted.

1. Schematic Description of Device Configuration

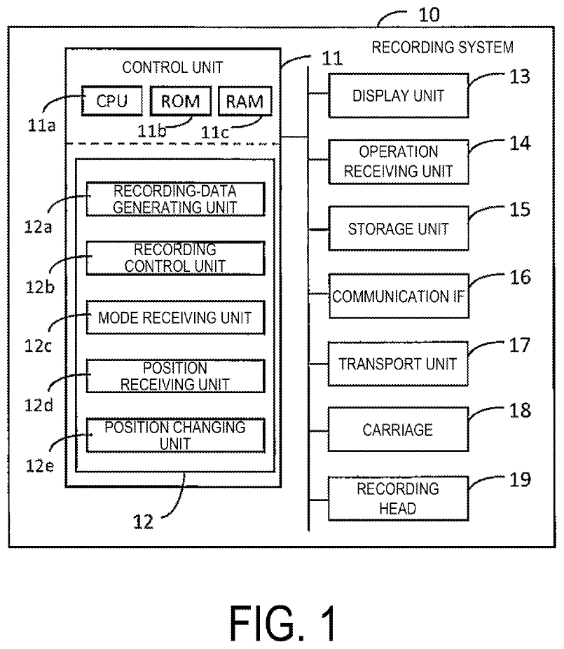

FIG. 1 schematically illustrates a configuration of a recording system 10 according to the present exemplary embodiment. A recording method is executed by the recording system 10.

The recording system 10 includes a control unit 11, a display unit 13, an operation receiving unit 14, a storage unit 15, a communication IF 16, a transport unit 17, a carriage 18, a recording head 19, etc. The IF is an abbreviation of interface. The control unit 11 is configured to include, as a processor, one or more ICs including a CPU 11a, a ROM 11b, a RAM 11c, and the like, another non-volatile memory, and the like.

In the control unit 11, a processor, that is, CPU 11a executes arithmetic processing according to a program 12 stored in ROM 11b or another memory, etc. using RAM 11c, etc. as a work area, thereby realizing various functions such as a recording-data generating unit 12a, a recording control unit 12b, a mode receiving unit 12c, a position receiving unit 12d, and a position changing unit 12e. The processor is not limited to one CPU, and may be configured to perform processing by a plurality of CPUs or a hardware circuit such as an ASIC, or may be configured to perform processing in cooperation with a CPU and a hardware circuit.

The display unit 13 is a means that displays visual information, and is constituted, for example, by a liquid crystal display, or an organic EL display. The display unit 13 may be configured to include a display and a drive circuit for driving the display. The operation receiving unit 14 is a means that receives an input by a user, and is realized by, for example, a physical button, a touch panel, a mouse, a keyboard, etc. Of course, the touch panel may be realized as a function of the display unit 13. The display unit 13 and the operation receiving unit 14 may be collectively referred to as an operation panel of the recording system 10.

The storage unit 15 is, for example, a storage means such as a hard disk drive, a solid state drive, or another memory. A part of the memory included in the control unit 11 may be regarded as the storage unit 15. The storage unit 15 may be regarded as a part of the control unit 11.

The communication IF 16 is a general term for one or a plurality of IFs for the recording system 10 to execute wired or wireless communication with an external device in accordance with a predetermined communication protocol including a known communication standard. The external device is, for example, a communication device such as a personal computer, a server, a smartphone, or a tablet terminal.

The transport unit 17 is a means that transports a medium 30 along a predetermined transport direction under the control of the control unit 11. The transport unit 17 includes, for example, a roller that rotates to transport the medium 30, a motor as a power source of rotation, etc. In addition, the transport unit 17 may be a mechanism that transports the medium 30 by mounting the medium 30 on a belt or a pallet that is moved by a motor. The medium 30 is, for example, a sheet of paper, but may be any medium that can be a target of recording by liquid, and may be a material other than paper, such as a film or a fabric.

The carriage 18 is a moving means that reciprocates along a predetermined main scanning direction by power of a carriage motor (not illustrated) under the control of the control unit 11. The main scanning direction and the transport direction intersect each other. The recording head 19 is mounted on the carriage 18.

The recording head 19 is a means that performs recording by discharging liquid onto the medium 30 by an inkjet method under the control of the control unit 11. The liquid is mainly ink, but the recording head 19 can also discharge liquid other than ink. The movement of the carriage 18 is synonymous with the movement of the recording head 19. The carriage 18 and the recording head 19 may be collectively regarded as the recording head 19 without being distinguished from each other.

The recording system 10 is implemented by coupling a plurality of devices or equipment to each other in a communicable manner. The recording system 10 includes, for example, an information processing device that serves as the control unit 11 and a printer that includes the transport unit 17, the carriage 18, and the recording head 19 and performs recording under the control of the information processing device. In this case, the information processing device can be understood as a recording control device, an image processing device, etc. The storage unit 15 may be a part of the information processing device or the printer, or may be a storage device that is not a part of either the information processing device or the printer and is accessible from the information processing device or the printer. Similarly, the display unit 13 and the operation receiving unit 14 may be a part of the information processing device or the printer, or may be a peripheral device coupled to the information processing device or the printer.

Alternatively, the recording system 10 may be configured to be realized by one printer including the control unit 11. When the recording system 10 is implemented by a single device, it can be referred to as the recording device 10.

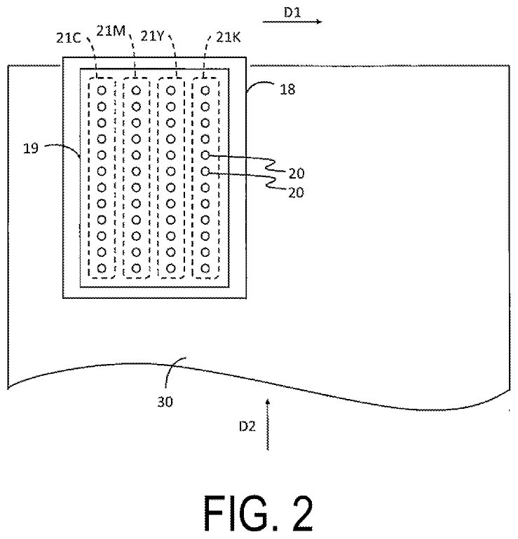

FIG. 2 simply illustrates a relationship between the medium 30, the recording head 19, etc. when viewed from above. As described above, the recording head 19 is mounted on the carriage 18, and can perform, together with the carriage 18, forward movement which is movement from one side to the other side along a main scanning direction D1 and backward movement which is movement from the other side to the one side. The recording head 19 includes a plurality of nozzles 20 for discharging liquid such as ink. Each of the white circles illustrated in FIG. 2 is an individual nozzle 20. A droplet discharged from the nozzle 20 is referred to as a dot.

The recording head 19 includes a nozzle group for each type of liquid. The recording head 19 is capable of discharging ink of a plurality of colors such as cyan (C), magenta (M), yellow (Y), and black (K). The recording head 19 may discharge various types of ink such as light cyan (Lc) and light magenta (Lm), and various types of liquid such as coating liquid and reaction liquid, in addition to the CMYK ink. The recording head 19 may be referred to as a liquid discharge head, a printing head, a print head, an inkjet head, etc.

In FIG. 2, four nozzle groups 21C, 21M, 21Y, and 21K are very simply illustrated. A nozzle group corresponding to one type of liquid is configured by the plurality of nozzles 20 in which a nozzle pitch, which is an interval between the nozzles 20 in a transport direction D2, is constant or substantially constant. The main scanning direction D1 and the transport direction D2 are orthogonal or substantially orthogonal to each other. The nozzle group 21C is a nozzle row including the plurality of nozzles 20 that discharge the C ink. Similarly, the nozzle group 21M is a nozzle row including the plurality of nozzles 20 that discharge the M ink, the nozzle group 21Y is a nozzle row including the plurality of nozzles 20 that discharge the Y ink, and the nozzle group 21K is a nozzle row including the plurality of nozzles 20 that discharge the K ink.

In FIG. 2, a nozzle arrangement direction in which the plurality of nozzles 20 constituting the same nozzle group are arranged is parallel to the transport direction D2. However, depending on a configuration of the recording head 19, the nozzle arrangement direction may obliquely intersect the transport direction D2. The transport unit 17 transports the medium 30 from upstream to downstream in the transport direction D2. The upstream and downstream in the transport direction D2 are also simply referred to as upstream and downstream. A plurality of nozzle groups such as the nozzle groups 21C, 21M, 21Y, and 21K included in the recording head 19 are arranged along the main scanning direction D1 and have the same position in the transport direction D2.

The control unit 11 causes the recording head 19 to discharge ink onto the medium 30 based on recording data representing an image. As is known, in the recording head 19, a driving element is provided for each nozzle 20, and application of a driving signal to the driving element of each nozzle 20 is controlled in accordance with recording data, whereby each nozzle 20 discharges a dot or does not discharge a dot, and an image represented by the recording data is recorded on the medium 30. When the configuration of FIG. 2 is referred, the recording data is data that defines dot discharge or dot non-discharge for each pixel and for each CMYK ink. The dot discharge is also referred to as dot-on, and dot non-discharge is also referred to as dot-off.

Liquid discharge by the recording head 19 in accordance with the movement of the carriage 18 is referred to as a pass or a main scan. A pass by the forward movement of the carriage 18 is referred to as a forward pass, and a pass by the backward movement of the carriage 18 is referred to as a backward pass. Recording performed in both the forward pass and the backward pass is bidirectional recording, and recording performed in only one of the forward pass or the backward pass is unidirectional recording.

The control unit 11 records an image represented by the recording data on the medium 30 by combining the pass by the carriage 18 and the recording head 19 and so-called paper feeding which is transport of the medium 30 by a predetermined distance by the transport unit 17. The transport of the medium 30 by the transport unit 17 corresponds to relative movement between the recording head 19 and the medium 30 in the transport direction D2, and this is also referred to as sub-scanning.

The control unit 11 can also vary a size of the dot discharged from the nozzle 20 by varying an amplitude, shape, etc. of the drive signal applied to the drive element of the nozzle 20 according to the recording data. The size of the dot is a dot diameter or a volume per dot. For example, the nozzle 20 can discharge dots of three types of sizes called a large dot, a medium dot, and a small dot. Small dot<medium dot<large dot is satisfied as for the size relationship. For the size of the dot that can be discharged by the nozzle 20, there may be two types or four or more types. Therefore, the dot-on data included in the recording data may be data indicating dot-on of any size.

2. Recording Control Processing

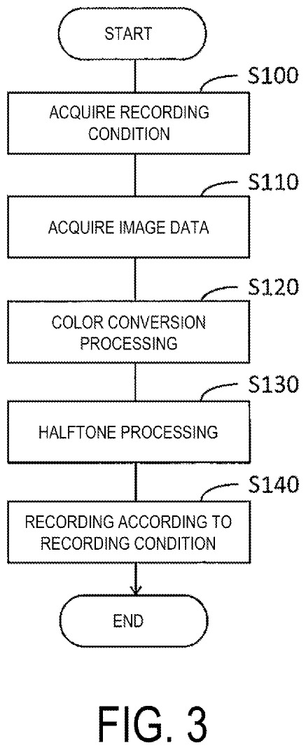

FIG. 3 is a flowchart illustrating recording control processing executed by the control unit 11 in accordance with the program 12.

In step S100, the control unit 11 acquires a recording condition for recording an image on the medium 30. In the present exemplary embodiment, the recording condition is a concept including a recording mode. The control unit 11 has a plurality of the recording modes, and can execute recording according to the recording mode designated from the outside. Examples of the recording mode include a “fine mode” in which relatively high image quality is realized, a “normal mode” in which the image quality is suppressed to be lower than that in the fine mode and the time required for recording is reduced, and a “quick mode” in which the image quality is further suppressed to be lower than that in the normal mode and the recording time is reduced. Of course, a name and type of the recording mode are not limited. The image quality and the recording time for each recording mode are different depending on a difference in various elements such as a number of passes executed per certain area of the medium 30, a recording resolution, a moving speed of the carriage 18, and a transport speed of the medium 30 by the transport unit 17. The user can sensuously select the recording mode from the names of such recording modes without designating the recording conditions in detail.

In addition, as the recording condition, for example, there are various conditions such as double-sided recording or single-sided recording, color recording or monochrome recording, bordered recording or borderless recording, a medium type, and a medium size of the medium 30. The control unit 11 can also specify one recording mode in accordance with a predetermined rule from a combination of designated recording conditions among these recording conditions. The control unit 11 acquires the recording condition through, for example, the operation receiving unit 14 or the display unit 13. That is, the user arbitrarily designates the recording condition including the recording mode by operation on a UI screen (not illustrated) displayed on the display unit 13, and the control unit 11 acquires the designated recording condition. The UI is an abbreviation of a user interface.

In step S110, the control unit 11 acquires image data representing an image to be recorded. For example, the control unit 11 acquires the image data instructed through operation of the operation receiving unit 14 by the user from a storage location of the image data such as the storage unit 15 or a memory inside or outside the recording system 10.

Alternatively, the control unit 11 receives and acquires the image data transmitted from the external device via the communication IF 16.

An execution order of steps S100 and S110 may not be as illustrated in FIG. 3, and step S110 may precede step S100, or these may be performed simultaneously or substantially simultaneously. For example, a recording execution instruction transmitted from the external device to the recording system 10 may include information designating the recording condition and image data, and the control unit 11 may acquire such a recording execution instruction to complete steps S100 and S110.

In step S120, the recording-data generating unit 12a of the control unit 11 executes color conversion processing on the image data acquired in step S110. The image data acquired in step S110 corresponds to “input data”. The recording-data generating unit 12a may perform resolution-conversion processing, etc. on the image data as necessary. The recording-data generating unit 12a performs color conversion processing to convert the color of each pixel constituting the image data into a tone value representing a discharge amount of each liquid used by the recording head 19. The discharge amount may be referred to as a recording amount, a recording rate, a duty, a print amount, etc.

The color space employed by the image data is not particularly limited. For example, it is assumed that the color of each pixel of the image data is expressed by a tone value in an RGB color space of red (R), green (G), and blue (B). According to the example of FIG. 2, the recording head 19 can perform recording using the CMYK ink. In this case, the recording-data generating unit 12a refers to a color conversion LUT 40 that defines a conversion relationship between RGB and CMYK, and converts a RGB tone value of each pixel of the image data into a CMYK tone value. The LUT is an abbreviation for look-up table. In the following description, it is assumed that the tone value is expressed by 256 tones of 0 to 255. The color conversion LUT 40 is stored in the storage unit 15 in advance. With respect to the color of the pixel of the image data, the sum of the tone values of the CMYK ink obtained by the color conversion processing, that is, C+M+Y+K is a“total discharge amount” corresponding to the color. Therefore, it can be said that the control unit 11 determines the total discharge amount, of the liquid, corresponding to the color of the input data, and controls the discharge of the liquid by the recording head 19 based on the determined total discharge amount, that is, controls the discharge of the liquid by the recording head 19 based on the total discharge amount, of the liquid, corresponding to the color of the input data.

In the recording of the inkjet system using the nozzle 20, such a discharge amount cannot be used for the recording as it is. Therefore, in step S130, the recording-data generating unit 12a performs halftone processing on the image data after the color conversion processing, and generates recording data in which dot-on or dot-off is defined for each pixel and each CMYK ink. The halftone processing can be executed using a dither method, an error diffusion method, etc. Of course, multi-value conversion may be performed in which for each pixel and for each CMYK ink, dot-on is determined to be any one of a large dot, a medium dot, or a small dot, instead of binary conversion in which only dot-on or dot-off is determined.

In step S140, the recording control unit 12b of the control unit 11 starts controlling the carriage 18, the recording head 19, and the transport unit 17, transfers the recording data generated in step S130 to the recording head 19, and causes the recording head 19 to discharge dots in accordance with the recording data, thereby performing recording on the medium 30. Of course, this recording is executed in accordance with the recording condition including the recording mode acquired in step S100. Thus, the flowchart of FIG. 3 is completed.

3. Features of Color Conversion LUT

Features of the color conversion LUT 40 used in the color conversion processing of the step S120 will be described.

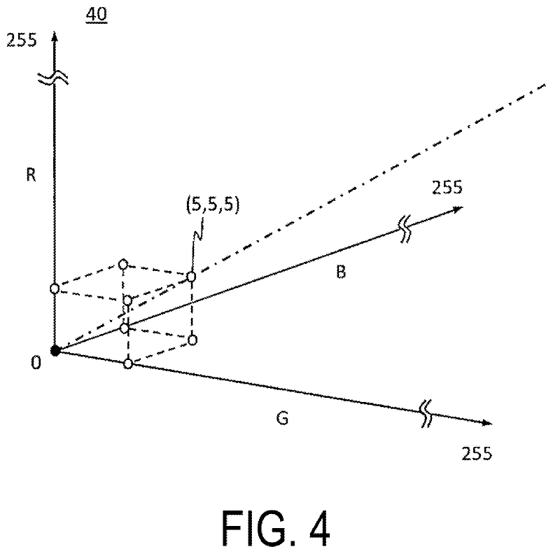

FIG. 4 schematically illustrates a part of the color conversion LUT 40 in the RGB color space. According to FIG. 4, the R-axis, the G-axis, and the B-axis each having a tone range of 0 to 255 are orthogonal to each other. The color conversion LUT 40 stores the CMYK tone value as the discharge amount in association with each of a plurality of grid points adjacent to each other at intervals in the RGB color space. In FIG. 4, the CMYK tone values are not described.

If the RGB of the pixel of the image data matches any of the grid points at which the color conversion LUT 40 stores the CMYK tone value, the recording-data generating unit 12a outputs the CMYK tone value stored at that grid point as the color conversion result of the pixel. On the other hand, if the RGB of the pixel of the image data does not match any of the grid points at which the color conversion LUT 40 stores the CMYK tone value, the color conversion result of the pixel is output by an interpolation operation that refers to the CMYK tone values stored at the plurality of grid points near the RGB of the pixel. As the interpolation calculation, a known interpolation method such as bilinear interpolation or bicubic interpolation can be employed.

In consideration of a processing load required for LUT generation and a storage capacity required for LUT storage, it is not realistic for the color conversion LUT to include discharge amounts for all combinations of the RGB each of which has a tone range of 0 to 255. In general, such an LUT includes the discharge amount for each grid point which is a combination of three axes of 17 tone values at equal intervals obtained by dividing each axis of the RGB into 16, for example.

In contrast to such a recent configuration, in the color conversion LUT 40 of the present exemplary embodiment, an “adjacent grid point” which is a grid point adjacent to the grid point of the darkest portion of the color space is positioned in a predetermined “first range” close to the darkest portion. When the darkest portion is 0 and the brightest portion of the color space is 1, the first range is a range of 1/25.5 or less excluding the darkest portion. Since the tone range is 0 to 255, the first range is a range such that the tone value excluding the darkest portion is 10 or less. If the tone range is expressed by 512 tones, the first range is a range such that the tone value excluding the darkest portion is 20 or less.

According to FIG. 4, the grid point of (R, G, B)=(0, 0, 0) indicated by a black circle is the darkest portion. The color of the darkest portion may be regarded as black. A straight line indicated by an alternate long and short dash line is a part of a gray axis coupling the darkest portion and the brightest portion of the RGB color space. The brightest portion is (R, G, B)=(255, 255, 255), and the color thereof may be regarded as white. In FIG. 4, for easy understanding, the adjacent grid points in the color conversion LUT 40 are indicated by white circles. In the example of FIG. 4, the RGB tone value of the adjacent grid points is 0 or 5. That is, seven grid points of (R, G, B)=(5, 0, 0), (0, 5, 0), (0, 0, 5), (5, 5, 0), (5, 0, 5), (0, 5, 5), and (5, 5, 5) are adjacent grid points. These adjacent grid points are all within the first range. In FIG. 4, other grid points whose distance from the darkest portion is longer than those of the adjacent grid points are not illustrated.

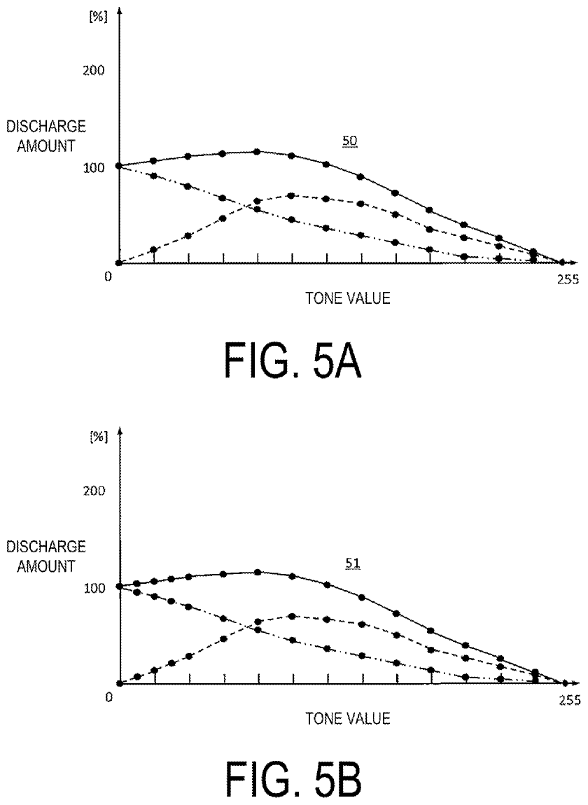

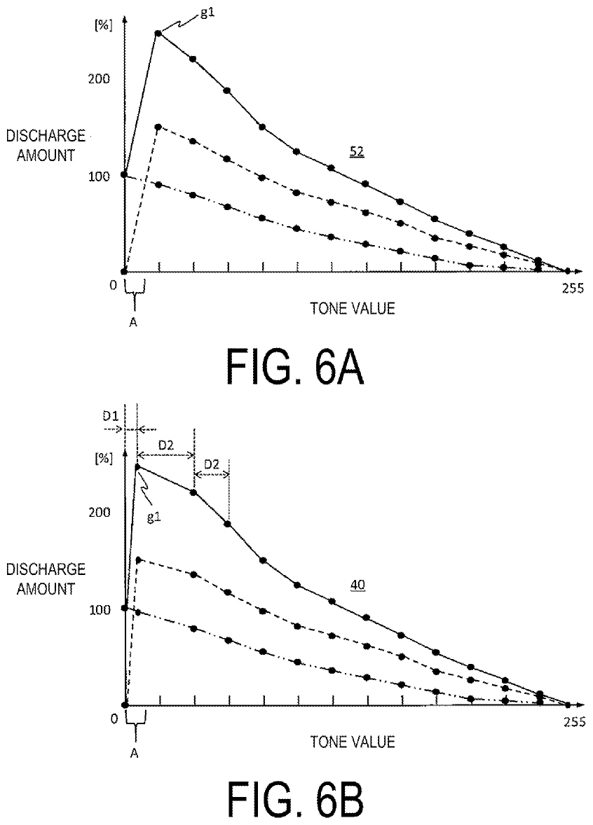

FIG. 5A shows a color conversion LUT 50 as a comparative example with respect to the color conversion LUT 40 of the present exemplary embodiment, and FIG. 5B shows a color conversion LUT 51 as a comparative example. FIG. 6A shows a color conversion LUT 52 as a comparative example.

On the other hand, FIG. 6B shows an example of the color conversion LUT 40 of the present exemplary embodiment.

Since views of FIGS. 5A, 5B, 6A, and 6B are the same, first, a basic view of FIGS. 5A, 5B, 6A, and 6B (hereinafter, FIG. 5A, etc.) will be described. In FIG. 5A, etc. the horizontal axis represents the tone value of the image data as the input data, and the vertical axis represents the discharge amount. In FIG. 5A, etc., the correspondence between inputs and outputs on the gray axis of the color conversion LUT is illustrated. As described above, the discharge amount is the CMYK tone value, but in FIG. 5A, etc., the discharge amount is expressed as a percentage. That is, the tone range of 0 to 255 corresponds to 0% to 100%.

In FIG. 5A, etc., black circles correspond to grid points on the gray axis. Each black circle at the same position in the horizontal axis direction indicates the discharge amount corresponding to the same one grid point. Specifically, black circles coupled by a two dot chain line indicates the discharge amount of the K ink, black circles coupled by a broken line indicates the sum of the discharge amounts of the CMY ink other than K, and black circles coupled by a solid line indicates the sum of the discharge amounts of the CMYK ink, that is, the total discharge amount. According to FIG. 5A, etc., with respect to the grid point of the tone value=0 on the horizontal axis, that is, the darkest portion, the discharge amount of the K ink=100% is defined, and the discharge amount of the CMY ink is defined as 0%.

The color conversion LUT 50 shown in FIG. 5A is a very general color conversion LUT in which the intervals of the grid points are equal or substantially equal over the input tone range of 0 to 255.

In the color conversion LUT 51 shown in FIG. 5B, the number of the color conversion LUT 50, the number of grid points is increased in a relatively dark range in the input tone range. Therefore, the interpolation accuracy of the discharge amount for the color in such a dark range is improved. However, the increase in the number of grid points causes problems such as an increase in processing load required for LUT generation and an increase in consumption of a storage capacity for LUT storage. In addition, according to the color conversion LUTs 50 and 51, since the total discharge amount slightly exceeds 100% in a part of the tone range of the input, in a dark portion of the image, the print amount of ink to the medium 30 is likely to be insufficient, that is, the filling of the medium surface is likely to be insufficient.

In the color conversion LUT 52 shown in FIG. 6A, the number of grid points is the same as that of the color conversion LUT 50, and the intervals between the grid points are equal or substantially equal to each other as in the color conversion LUT 50. In the color conversion LUT 52, with respect to a grid point g1 at the position closest to the grid point of the darkest portion, by mainly increasing the discharge amount of the CMY ink other than the K ink, the total discharge amount of the grid point g1 is greatly increased as compared with the color conversion LUTs 50 and 51. As a result, the shortage of the ink print amount in the dark portion of the image is eliminated as compared with the color conversion LUTs 50 and 51.

However, in the color conversion LUT 52, the distance between the grid point of the darkest portion and the grid point g1 is the same as the distance between the other grid points. Therefore, it cannot be said that the interpolation accuracy of the discharge amount regarding the neighboring color of the darkest portion is high. Further, the filling of the medium surface by the neighboring color of the darkest portion is still insufficient. In a photographic image, etc., for example, a shadow, the hair of a person, or another dark portion often has a black-based color that is slightly brighter than the darkest portion and belongs to the first range described above. Therefore, the interpolation accuracy and the filling of the medium surface with respect to the color belonging to the first range are particularly important for the image quality. A color belonging to the first range may be regarded as a neighboring color of the darkest portion. In FIGS. 6A and 6B, the first range is indicated by reference character A. As shown in FIG. 6A, in the color conversion LUT 52, since the position of the grid point g1 is outside the first range A, the problems of the interpolation accuracy and the filling of the medium surface regarding the neighboring color of the darkest portion cannot be solved.

The color conversion LUT 40 solves each of the problems described with respect to such color conversion LUTs 50, 51, 52. According to the color conversion LUT 40, the grid point g1 which is an adjacent grid point of the darkest portion is present within the first range A. The grid point g1 of the color conversion LUT 40 is one of the adjacent grid points described with reference to FIG. 4, and as a specific example, may be understood to correspond to the adjacent grid point of (R, G, B)=(5, 5, 5). As is clear from FIG. 6B, the total discharge amount at the grid point g1 is the peak total discharge amount defined by the color conversion LUT 40, and is greater than the total discharge amount corresponding to the darkest portion. According to FIG. 6B, the total discharge amount at the grid point g1 is an amount exceeding 200%. Therefore, the control unit 11 controls the discharge of the liquid by the recording head 19 based on the total discharge amount, of the liquid, corresponding to the color of the input data (steps S120 to S140), and in step S120, when a predetermined color belonging to the first range A in the color space of the input data is input as the color of the input data, the peak total discharge amount is determined. That is, when a predetermined color belonging to the first range A is input as the color of the input data, in steps S130 and S140, control is performed such that the peak total discharge amount is discharged by the recording head 19. The color of the grid point g1 in the RGB color space illustrated in FIGS. 4 and 6B corresponds to a specific example of the predetermined color.

The feature that the grid point g1 is within the first range A can also be understood from the aspect in which, as shown in FIG. 6B, D1<D2, where D1 is the interval between the grid point of the darkest portion and the grid point g1 which is an adjacent grid point and D2 is the interval between the grid points other than the interval D1. That is, the number of grid points does not change between the color conversion LUT 40 and the color conversion LUT 52. According to such a color conversion LUT 40, it is possible to interpolate the discharge amount corresponding to the neighboring color of the darkest portion with high accuracy without increasing the number of grid points, and it is possible to determine the total discharge amount of the neighboring color of the darkest portion to a sufficient amount so as not to be filled and insufficient in the recording result.

According to the color conversion LUT 40, since the total discharge amount of the darkest portion of R=G=B=0 is only K=100%, that is, K=255, a chromatic color is not mixed in a black character or ruled line, and the qualities of the blackness of the character or ruled line can be maintained. Although FIG. 6B shows the discharge amount corresponding to each grid point positioned on the gray axis of the RGB color space, in the color conversion LUT 40, for example, it may be understood that the adjacent grid points on each of the R-axis, the G-axis, and the B-axis also have CMYK tone values such that the total discharge amount is the largest as compared with other grid points on the axes.

4. Summary:

As described above, according to the present exemplary embodiment, the recording system 10 includes the recording head 19 including the plurality of nozzles 20 capable of discharging liquid onto the medium 30, and the control unit 11 that controls the recording head 19. The control unit 11 controls discharge of the liquid by the recording head 19 based on the total discharge amount, of the liquid, corresponding to a color of the input data, and performs control to discharge the peak total discharge amount of the liquid when the predetermined color belonging to the first range in the color space of the input data is input as the color of the input data. The peak total discharge amount is greater than the total discharge amount corresponding to the darkest portion of the color space, and the first range is a range of 1/25.5 or less excluding the darkest portion when the darkest portion is 0 and the brightest portion of the color space is 1.

According to the above-described configuration, the control unit 11 sets the peak total discharge amount in correspondence with the predetermined color belonging to the first range, and thus it is possible to eliminate insufficient filling of the medium surface in the recording result with respect to the color in the first range, which is the neighboring color of the darkest portion, and to provide the recording result with excellent image quality.

Further, according to the present exemplary embodiment, the recording system 10 includes the LUT that stores the total discharge amount in association with each of the plurality of grid points adjacent to each other at intervals in the color space. The control unit 11 performs control to discharge the total discharge amount, of the liquid, corresponding to the color of the input data with reference to the LUT, the LUT includes an adjacent grid point in the first range, the adjacent grid point being, of the plurality of grid points, a grid point adjacent to the grid point of the darkest portion, and D1<D2, where D1 is an interval between the grid point of the darkest portion and the adjacent grid point and D2 is an interval between grid points other than the interval D1.

According to the above-described configuration, in a situation where the LUT including the information of the total discharge amount in association with the limited grid points is used, the adjacent grid points are included in the first range, and D1<D2 is satisfied, whereby it is possible to solve the above-described insufficient filling with respect to the neighboring color of the darkest portion without increasing the data amount of the LUT.

The peak total discharge amount is an amount exceeding 200% in the example of FIG. 6B, and such a peak total discharge amount will be additionally described. As an example, the peak total discharge amount is equal to or greater than such an amount that the medium 30 is invisible in a result of recording an image of a predetermined area in the predetermined color on the medium 30. “The medium 30 is invisible” means that the color of the medium 30 itself, for example, the white color of the paper surface, is invisible. The predetermined color is a color represented by the RGB of the grid point g1 of FIG. 6B. Further, an image of a predetermined area is, for example, a color patch, and specifically, a color patch of vertical and horizontal 6 mm×6 mm.

That is, it is assumed that the control unit 11 records image data representing a color patch, which is a set of pixels including RGB of the grid point g1 in FIG. 6B, on the medium 30 after performing color conversion processing with reference to the color conversion LUT 40. At this time, when the recorded color patch is visually evaluated, the surface of the medium is sufficiently covered with the ink so that the color of the medium 30 cannot be visually recognized in the range of the color patch.

According to the present exemplary embodiment, by setting the peak total discharge amount in this manner, it is possible to obtain a recording result in which the medium 30 is sufficiently covered so as not to be visually recognized when the neighboring color of the darkest portion is recorded.

The present exemplary embodiment is not limited to a system or a device, and discloses disclosures of various categories such as a method including steps executed by a system or a device, and a non-transitory computer-readable storage medium storing the program 12 for causing a processor to execute the method.

### 5. Modified Examples

Modified examples included in the present exemplary embodiment will be described. According to the modified example, as illustrated in FIG. 1, the recording system 10 includes the position changing unit 12e, the mode receiving unit 12c, and the position receiving unit 12d.

The color conversion LUT 40 may be stored in the storage unit 15 in advance as described above, but the control unit 11 may generate the color conversion LUT 40 as necessary. That is, in the recording system 10, the position changing unit 12e may be capable of changing the positions of grid points in the color space of the input data. For example, it is assumed that the storage unit 15 stores the color conversion LUT 52 shown in FIG. 6A in advance. The position changing unit 12e generates the color conversion LUT 40 from the color conversion LUT 52 by moving the adjacent grid points including the grid point g1 in the color conversion LUT 52 into the first range.

For example, in the color conversion LUT 52, when the grid point g1 is (R, G, B)=(16, 16, 16), the position changing unit 12e changes the grid point g1 to a predetermined position of any of (R, G, B)=(5, 5, 5) to (10, 10, 10) on the gray axis, and then the color conversion LUT 40 is obtained. On the gray axis, for example, (R, G, B)=(1, 1, 1) to (10, 10, 10) is the first range.

When changing the position of the grid point, the position changing unit 12e also changes the CMYK tone value stored in association with the grid point in the color conversion LUT. In the case of the grid point g1, the total sum of the CMYK tone values is determined to some extent as the peak total discharge amount, for example, 200% or more. However, the position changing unit 12e changes the ratio or the total sum of the CMYK tone values within such a restriction, and changes the CMYK tone values to match the RGB color of the grid point g1 after the position change. For example, in the L*a*b* color space, which is a device-independent color space, the CMYK tone values, which realize a color that is within a predetermined color difference and close to the color to which the RGB of the grid point g1 after the position change corresponds, are stored in association with the grid point g1 after the position change.

According to such a configuration, the control unit 11 can generate the color conversion LUT 40 according to the present exemplary embodiment based on a certain color conversion LUT.

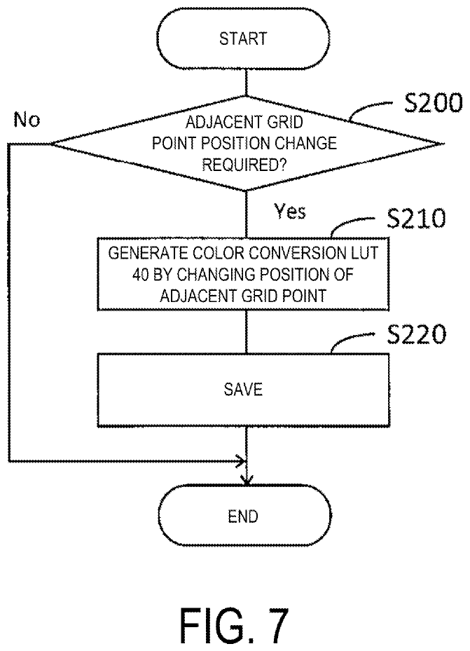

FIG. 7 is a flowchart illustrating an example of the grid point position changing processing executed by the control unit 11 according to the program 12. The control unit 11 can execute the flowchart of FIG. 7 in parallel with a part of the flowchart of FIG. 3 or at a timing different from that of the flowchart of FIG. 3.

In step S200, the position changing unit 12e determines whether it is necessary to change the position of the adjacent grid point. When it is necessary to change the position of the adjacent grid point, the processing proceeds to step S210 from the determination of “Yes”. On the other hand, when it is not necessary to change the position of the adjacent grid point, the processing of the flowchart of FIG. 7 ends from the determination of “No”. However, the position changing unit 12e may repeat the determination of step S200 as needed until “Yes” is determined in step S200.

Specific methods of the determination in step S200 are mainly the following three methods.

The position receiving unit 12d can receive a designation of the position of the adjacent grid point. That is, the user arbitrarily designates the position of the adjacent grid point by operating the operation receiving unit 14, and the position receiving unit 12d receives the designation. Through the UI screen, the user can designate the position of the adjacent grid point from a default position by, for example, any one of tone values of 5 to 10. The default position is a position outside the first range, and the tone values of 5 to 10 are positions within the first range.

Therefore, when the position receiving unit 12d receives the designation of the position within the first range, the position changing unit 12e determines “Yes” in step S200 and proceeds to step S210.

In step S210, the position changing unit 12e changes the position of the adjacent grid point in accordance with the designated position received by the position receiving unit 12d. For example, if the position of the adjacent grid point is designated by the tone value=5, the position of the adjacent grid point is changed to a position corresponding to the tone value=5 in the RGB color space as illustrated in FIG. 4. The change of the position of the adjacent grid point into the first range and the generation of the color conversion LUT 40 by the change are as described above.

In step S220, the position changing unit 12e stores the color conversion LUT 40 generated by the position change in step S210 in the storage unit 15 and ends the flowchart in FIG. 7. Thereafter, the recording-data generating unit 12a can execute the color conversion processing in step S120 in FIG. 3 using the color conversion LUT 40.

According to such a configuration, it is possible to adjust the position of the adjacent grid point according to the intention of the user. Therefore, the image quality of the neighboring color of the darkest portion also becomes the image quality desired by the user.

Instead of changing the position of the adjacent grid point in accordance with the user's intention, the position changing unit 12e may change the position of the adjacent grid point in accordance with the color included in the input data and the darkest color excluding the darkest portion. To be more specific, in response to the acquisition of the image data in step S110 in FIG. 3, the position changing unit 12e specifies the darkest color (hereinafter, semi-darkest portion) excluding the darkest portion of R=G=B=0 among the colors included in the image data. If the color of the semi-darkest portion falls within the first range, the position changing unit 12e determines “Yes” in step S200 and proceeds to step S210. On the other hand, if the color of the semi-darkest portion does not fall within the first range, the color conversion LUT 52 may be used as it is, and thus “No” is determined in step S200.

In step S210, the position changing unit 12e changes the position of the adjacent grid point in accordance with the semi-darkest portion. For example, if the semi-darkest portion is a color having a tone value of 8, the position of the grid point g1 is changed to a position corresponding to a tone value of 8 on the gray axis in the RGB color space. The positions of the adjacent grid points other than the grid point g1 are also changed to the positions within the first range corresponding to the tone value=8. The change of the position of the adjacent grid point into the first range and the generation of the color conversion LUT 40 by the change are as described above.

According to such a configuration, it is possible to adjust the position of the adjacent grid point according to the semi-darkest portion of the input data. Therefore, the image quality of the neighboring color of the darkest portion is optimized in accordance with the input data.

Alternatively, the position changing unit 12e may change the position of the adjacent grid point in accordance with the designated recording mode. The mode receiving unit 12c can receive the designation of the recording mode. As described above, since the user can arbitrarily designate the recording mode through the UI screen, the mode receiving unit 12c receives the designation of the recording mode. When the recording mode received by the mode receiving unit 12c is a predetermined mode for realizing relatively high image quality such as the “fine mode” described above, the position changing unit 12e determines “Yes” in step S200 and proceeds to step S210. On the other hand, if the recording mode received by the mode receiving unit 12c is not the predetermined mode, “No” is determined in step S200. The change of the position of the adjacent grid point into the first range and the generation of the color conversion LUT 40 by the change are as described above.

According to such a configuration, since it is possible to adjust the position of the adjacent grid point according to the recording mode, the image quality to be realized by the recording mode is accurately realized in the recording result.

In such a modified example, a plurality of specific examples can be combined.

For example, when the designated recording mode is a predetermined mode such as the fine mode and the designation of the position of the adjacent grid point is received from the user, the position changing unit 12e may determine “Yes” in step S200 and execute step S210. Alternatively, when the designated recording mode is the predetermined mode such as the fine mode or when the designation of the position of the adjacent grid point is received, “Yes” may be determined in step S200 and step S210 may be executed.

In addition, when the designated recording mode is the predetermined mode such as the fine mode and the semi-darkest portion of the input data has a color that falls within the first range, the position changing unit 12e may determine “Yes” in step S200 and execute step S210. Alternatively, when the designated recording mode is the predetermined mode such as the fine mode, or when the color of the semi-darkest portion of the input data falls within the first range, “Yes” may be determined in step S200, and step S210 may be executed.

As described above, the position changing unit 12e can not only generate the color conversion LUT by changing the position of the adjacent grid point into the first range based on the color conversion LUT in which the adjacent grid point is outside the first range, but also regenerate the color conversion LUT by changing the position of the adjacent grid point to another position in the first range based on the color conversion LUT in which the adjacent grid point is within the first range according to the position designated by the user, the position of the semi-darkest portion of the image, and the type of the recording mode. In addition, the position changing unit 12e can change the positions of grid points other than the grid point of the darkest portion and the adjacent grid point in accordance with the change of the position of the adjacent grid point. However, even in this case, the position is changed so that the interval D1<the interval D2 is maintained.

The color space of the input data is not limited to the RGB color space, and may be a CMYK color space. That is, the color conversion processing may be processing of converting CMYK to CMYK discharge amounts or processing of converting CMYK to CMYKLcLm discharge amounts. It is assumed that the color space of the input data is the CMYK color space and each color is represented by 256 tones. In this case, the darkest portion of the color space is a grid point of C=M=Y=K=255, the brightest portion is a grid point of C=M=Y=K=0, and a range of 1/25.5 or less excluding the darkest portion may be set as the first range when the darkest portion is 0 and the brightest portion is 1.

The color conversion processing may be executed using, for example, a function that defines a conversion rule from input to output, instead of the LUT that defines a conversion relationship from input to output for a plurality of grid points.

In addition to the reciprocating movement along the main scanning direction D1, the carriage 18 may be capable of executing reciprocating movement along the transport direction D1 intersecting the main scanning direction D2. That is, the carriage 18 may be configured to perform recording on the medium 30 by two dimensionally moving in a plane parallel to the surface of the stationary medium 30. In addition, the recording system 10 may not include the carriage 18. That is, the recording head 19 may be a so-called line type head which is stationary on the transport path by the transport unit 17 and in which the nozzle arrangement direction is not directed to the direction D2 as in FIG. 2 but is directed to the direction D1, and may be configured to perform recording by discharging liquid to the medium 30 passing under the recording head 19.

What is claimed is:

1. A recording system comprising:
a recording head including a plurality of nozzles configured to discharge liquid onto a medium; and
a control unit configured to control the recording head, wherein
the control unit is configured to:
control discharge of the liquid by the recording head based on a total discharge amount, of the liquid, corresponding to a color of input data and
perform control to discharge a peak total discharge amount of the liquid when a predetermined color belonging to a first range in a color space of the input data is input as the color of the input data,
the peak total discharge amount is greater than the total discharge amount corresponding to a darkest portion of the color space, and
the first range is a range of 1/25.5 or less excluding the darkest portion when the darkest portion is 0 and a brightest portion of the color space is 1.

2. The recording system according to claim 1, wherein
the peak total discharge amount is equal to or greater than such an amount that the medium is invisible in a result of recording an image of a predetermined area on the medium in the predetermined color.

3. The recording system according to claim 1, further comprising
a look-up table storing the total discharge amount in association with each of a plurality of grid points adjacent to each other at intervals in the color space, wherein
the control unit is configured to perform control to discharge the total discharge amount, of the liquid, corresponding to the color of the input data with reference to the look-up table,
the look-up table includes an adjacent grid point in the first range, the adjacent grid point being, of the plurality of grid points, a grid point adjacent to a grid point of the darkest portion, and
D1<D2, where D1 is an interval between the grid point of the darkest portion and the adjacent grid point and D2 is an interval between the plurality of grid points other than the interval D1.

4. The recording system according to claim 3, further comprising
a position changing unit configured to change a position of a grid point of the plurality of grid points in the color space.

5. The recording system according to claim 4, further comprising
a position receiving unit configured to receive a designation of a position of the adjacent grid point, wherein
the position changing unit is configured to change the position of the adjacent grid point in accordance with the designated position received by the position receiving unit.

6. The recording system according to claim 4, wherein
the position changing unit is configured to change a position of the adjacent grid point in accordance with a darkest color included in the input data excluding that of the darkest portion.

7. The recording system according to claim 4, further comprising
a mode receiving unit configured to receive a designation of a recording mode, wherein
the position changing unit is configured to change a position of the adjacent grid point in accordance with the designated recording mode received by the mode receiving unit.
